(19) United States
(12) Patent Application Publication
(10) Pub. No.: US 2005/0068253 A1
(43) Pub. Date: Mar. 31, 2005

(54) SYSTEM AND METHOD FOR EXTENDING THE DISPLAY VIEWING RANGE OF A COMPUTING DEVICE

(75) Inventor: Gunnar Bartels, Trier (DE)

Correspondence Address: Gunnar Bartels, Im Treff 20, Trier, 54296, DE

(73) Assignee: Gunnar Bartels, Trier (DE)

(21) Appl. No.: 10/709,841

(22) Filed: Jun. 1, 2004

Related U.S. Application Data
(60) Provisional application No. 60/474,308, filed on May 30, 2003.

(51) Int. Cl. G09G 5/00

(52) U.S. Cl. 345/1.3

(57) ABSTRACT

A system and method is provided which increases the viewing range of a first computing device by using the display of a second computing device as an additional viewing space of the first computing device. In accordance with an embodiment of the invention, a virtual video device driver, installed on the first computing device, activates the multi-monitor functionality of a graphical user interface operating system. The screen content of an extended display of the first computing device is sent to the second computing device via a data connection connecting the first and second computing device, and is used by viewer software installed on the second computing device to display associated content on a display of the second computing device.

### CROSS-REFERENCE TO RELATED APPLICATIONS

This application claims the benefit of U.S. Provisional Application No. 60/474,308, filed May 30, 2003, the contents of which are herein incorporated by reference.

### FIELD OF THE INVENTION

The present invention relates generally to video displays of computing devices, and more specifically to a system and method for extending the display viewing range of a computing device

### BACKGROUND OF THE INVENTION

There exists a demand by users of personal computers with operating systems that support graphical user interfaces such as modern versions of Microsoft Windows or Apple Mac OS for means to maximize the viewing range of displays, in order to gain simultaneous visual access to as much information as possible. For example, a user may wish to view multiple program windows, documents, pictures and videos simultaneously.

In accordance with one known solution, a user may be provided with a display monitor that offers a larger screen size, which makes additional viewing space available to the user. However, the maximum possible screen size that can be practically achieved is typically limited. Furthermore, the cost of such display monitors can increase significantly as the screen size provided increases.

In accordance with another known solution, multiple display monitors can be connected to a user's computer to provide additional viewing space. This solution requires that each display monitor be coupled to an additional video card residing on the user's computer. Certain operating systems (e.g. Microsoft Windows XP) may then transmit data corresponding to a number of portions into which a virtual desktop space is divided to the display monitors through the respective video cards, so that each portion is displayed on a selected display monitor of the user's computer. A user may then move a mouse cursor past the edge of one display to access a window on another display. This solution requires that the user's computer provide multiple slots for video cards. However, the number of expansion slots typically available in a personal computer is generally limited, and some mobile computing devices do not support the addition of multiple video cards at all.

### SUMMARY OF THE INVENTION

Embodiments of the invention are generally directed to a system and method for increasing or extending the viewing range of a first computing device, by using the display of a second computing device as an additional viewing space for the first computing device.

In one broad aspect of the invention, there is provided a system for extending the viewing range of a first computing device by employing a display of a second computing device coupled to the first computing device, the system comprising: a virtual video device driver, wherein the virtual video device driver resides on the first computing device; and a viewer software module residing on the second computing device, wherein the viewer software module is programmed to receive data used to display content on the display of the second computing device; wherein the virtual video device driver is adapted to emulate a physical video card such that in operation, an operating system of the first computing device communicates display content data to the virtual video device driver, through which the display content data is transmitted to the viewer software module.

In another broad aspect of the invention, there is provided a virtual video device driver adapted to emulate a physical video card, such that in operation, data is received from an operating system of a first computing device on which the virtual video device driver resides and is subsequently transmitted to a second computing device, wherein display content associated with the data is displayed on a display of the second computing device.

In another broad aspect of the invention, there is provided a method of extending the viewing range of a first computing device by employing a display of a second computing device coupled to the first computing device, the method comprising the steps of: receiving display content data from an operating system of the first computing device; transmitting the display content data to the second computing device; and displaying display content associated with the display content data on the display of the second computing device.

### BRIEF DESCRIPTION OF THE SEVERAL VIEWS OF THE DRAWING

For a better understanding of embodiments of the invention, and to show more clearly how it may be carried into effect, reference will now be made, by way of example, to the accompanying drawings in which:

FIG. 1 is a block diagram illustrating data flow in an example multi-monitor setup where two video cards are installed in a single computing device; and

FIG. 2 is a block diagram illustrating data flow in a multi-monitor setup utilizing more than one computing device, in accordance with an embodiment of the invention.

### DETAILED DESCRIPTION OF THE INVENTION

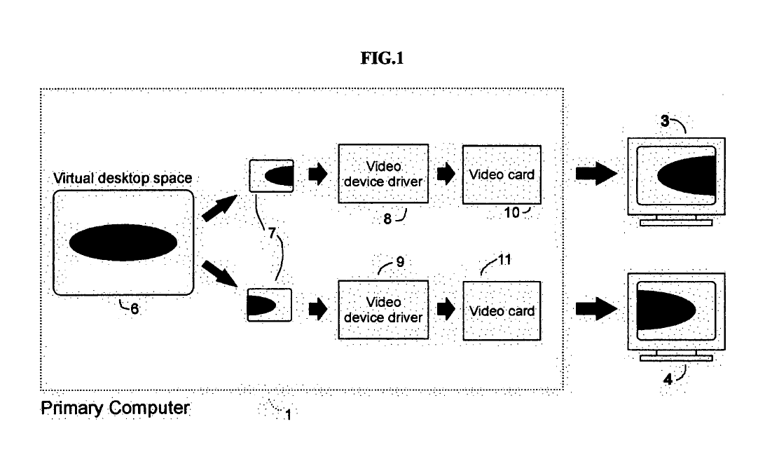

Referring to FIG. 1, a block diagram illustrating data flow in an example multi-monitor setup where two video cards are installed in a single computing device is shown. In order to provide more viewing space on a first computing device referred to herein, for ease of exposition, as a primary computer 1, an additional hardware display monitor 4 connected to an additional hardware video card 11 is provided in addition to hardware display monitor 3 connected to hardware video card 10. An operating system [not explicitly shown] executing on primary computer 1 (e.g. Microsoft Windows XP) recognizes both video device driver 8 and additional video device driver 9, installed on primary computer 1. The operating system generates display content data for a virtual desktop space 6, which is split into data for two screens 7, so that each portion of virtual desktop space 6 can be displayed on monitors 3,4 respectively. The operating system is adapted to permit users to navigate the displays on monitors 3,4 by moving a mouse cursor (or some other indicator) across the edge of one display to access components (e.g. other windows) on the other display.

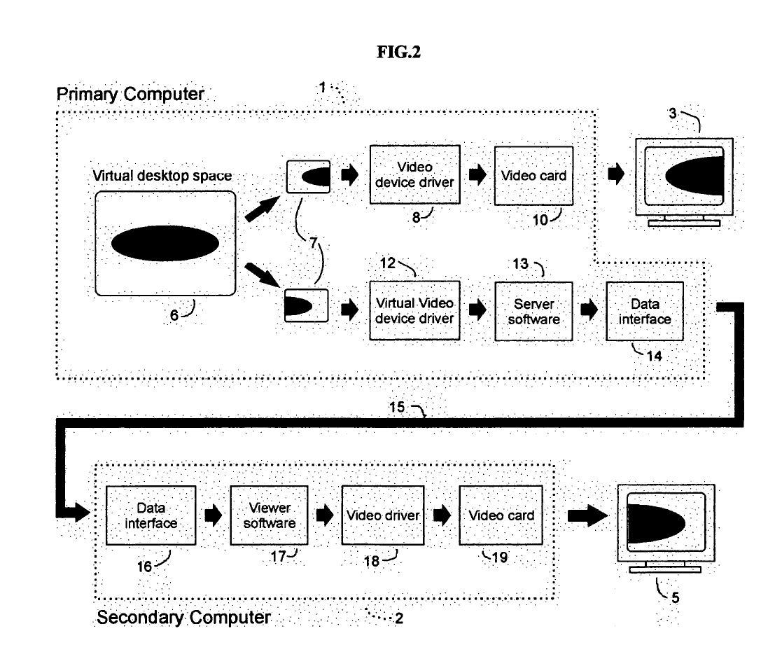

An improved means of extending the display viewing range of a computing device is now described with reference to FIG. 2.

Referring to FIG. 2, a block diagram illustrating data flow in a multi-monitor setup utilizing more than one computing device, in accordance with an embodiment of the invention is provided.

Generally, video device driver (e.g. video device driver 8) is a software component that enables an operating system of a computing device to communicate with the corresponding video card (e.g. video card 10) to output the graphical user interface on a display (e.g. display 3), which is connected to the video card.

In accordance with this embodiment of the invention, a virtual video device driver 12 is provided. Virtual video device driver 12 is installed on primary computer 1, and integrates into an operating system of primary computer 1 like a device driver of a physical hardware device, however virtual video device driver 12 emulates the hardware.

For example, by comparison, a virtual compact disc read-only memory (CD-ROM) device driver emulates a CD-ROM drive, which is recognized and accessed by the operating system with the same methods as a physical CD-ROM drive. However, in this example, the data content of the CD-ROM is not coming from a physical disc but from an image file stored on a hard-disk drive.

Virtual video device driver 12 emulates a physical video card in accordance with this embodiment of the invention. Virtual video device driver 12 is installed onto the primary computer 1 which viewing range shall be extended. The operating system (e.g. modern operating systems such as Microsoft Windows XP which have built-in multi-monitor capabilities) recognizes the additional virtual video device driver 12 in the same way as a video driver of a physical video card, and extends the virtual desktop space 6 to all installed video cards (through drivers 8,12 as shown in FIG. 2).

In an embodiment of the invention, virtual video device driver 12 feeds the display content data generated by the operating system to a server software module or component 13. Server software module 13 sends this display content data in a suitable format via a data interface 14 of primary computer 1 to a data interface 16 of a secondary computer 2 via a data connection 15. It will be understood by persons skilled in the art that any of numerous known types of different data connections may be employed, including but not limited to Ethernet, a wireless connection, Firewire, Universal Serial Bus, etc.

In an embodiment of the invention, a viewer software module or component 17 running on secondary computer 2 receives the display content data. Viewer software module 17 receives the display content data from the data interface 16, and sends the display content to the video driver 18 of a video card 19, which is installed on secondary computer 2.

One potential advantage of embodiments of the invention is that there is no longer a need to provide a proprietary multi-monitor service to split the display viewing range. Instead, the existing functionality of the operating system or any other multi-display software application of a third party company may be utilized to split the virtual desktop space into slices or portions. Furthermore, embodiments of the invention may also permit the display of a laptop or tablet-type personal computer to be used as an additional display, even where such devices may not explicitly support additional video inputs.

It will be understood by persons skilled in the art that the data flow illustrated in the embodiment described with reference to FIG. 2 also depicts a method of extending the viewing range of a first computing device by employing a display of a second computing device coupled to the first computing device. Generally speaking, the method comprising the steps of receiving display content data from an operating system of the first computing device, transmitting the display content data to the second computing device, and displaying display content associated with the display content data on the display of the second computing device.

The steps of a method of extending the viewing range of a first computing device in embodiments of the invention may be provided as executable software instructions stored on a computer-readable medium.

The invention has been described with regard to a number of embodiments. However, it will be understood by persons skilled in the art that other variants and modifications may be made without departing from the scope of the invention as defined in the claims appended hereto.

1. A system for extending the viewing range of a first computing device by employing a display of a second computing device coupled to said first computing device, the system comprising:
a virtual video device driver, wherein said virtual video device driver resides on said first computing device; and
a viewer software module residing on said second computing device, wherein said viewer software module is programmed to receive data used to display content on the display of said second computing device;
wherein said virtual video device driver is adapted to emulate a physical video card such that in operation, an operating system of said first computing device communicates display content data to said virtual video device driver, through which said display content data is transmitted to said viewer software module.

2. The system of claim 1, further comprising a server software module coupled to said virtual video device driver, wherein said server software module facilitates transmission of display content data communicated to said virtual video device driver, from said first computing device to said second computing device.

3. The system of claim 1, further comprising a video card and an associated video driver residing on said second computing device, wherein said viewer software module is further programmed to communicate received data to said video card such that content associated therewith is displayed on the display of said second computing device.

4. A virtual video device driver adapted to emulate a physical video card, such that in operation, data is received from an operating system of a first computing device on which said virtual video device driver resides and is subsequently transmitted to a second computing device, wherein display content associated with said data is displayed on a display of said second computing device.

5. A method of extending the viewing range of a first computing device by employing a display of a second computing device coupled to said first computing device, the method comprising the steps of:
receiving display content data from an operating system of said first computing device;
transmitting said display content data to said second computing device; and
displaying display content associated with said display content data on the display of said second computing device.
